(19) United States
(12) Patent Application Publication
(10) Pub. No.: US 2026/0348343 A1
(43) Pub. Date: Nov. 5, 2026

(54) FUEL INJECTOR

(71) Applicant: PHINIA DELPHI LUXEMBOURG SARL, Belvaux (LU)

(72) Inventors: Diego GUERRATO, Gillingham (GB); Michael Peter COOKE, Rochester (GB)

(21) Appl. No.: 19/487,805

(22) PCT Filed: May 31, 2024
(86) PCT No.: PCT/EP2024/065107

§ 371 Date: Nov. 25, 2025

(30) Foreign Application Priority Data
Jun. 1, 2023 (GB) 2308191.2

(51) Int. Cl. F02M 21/02

(52) U.S. Cl. CPC F02M 21/0263; F02M 2200/30

(57) ABSTRACT

A fuel injector for delivering gaseous fuel to an internal combustion engine includes a valve needle which is engageable with a valve needle seat to control delivery of gaseous fuel in a combustion space; and an actuator for causing the valve needle to move through a range of travel between a seated position in which it engages the valve needle seat and a fully open position. A damping arrangement includes a damping chamber filled with a damping fluid which serves to damp opening movement of the valve needle as it moves away from the valve needle seat and further includes a damping valve which is cooperable with a damping valve seat to control the exit of damping fluid from the damping chamber to a low pressure drain, the damping valve being configured to disengage from the damping valve seat in response to movement of the valve needle.

### FIELD OF THE INVENTION

This invention relates to a fuel injector for use in a gaseous fuel injection system. In particular, the invention relates to a fuel injector for gaseous fuel such as hydrogen for delivering fuel to an internal combustion engine.

### BACKGROUND

In fuel injection systems for liquid fuel, it is known for a fuel pump to supply fuel to a high-pressure accumulator (or common rail), from where it is delivered into each cylinder of the engine by means of a dedicated fuel injector. Typically, a fuel injector has an injection nozzle that is received within a bore provided in a cylinder head of the cylinder, and a valve needle which is actuated to control the release of high-pressure fuel into the cylinder from spray holes provided in the injection nozzle. One simple way of opening and closing a valve needle is to couple a solenoid actuator directly to the valve needle, by attaching an armature of the actuator to the valve needle (or by providing a valve needle with an integral armature). The valve needle is biased towards a seating surface so that, when the solenoid is not energised, the valve needle prevents fuel flow through the spray holes. When the solenoid is actuated, the valve needle is lifted away from its valve seat and fuel injection takes place.

One of the challenges with hydrogen fuel (and other gas fuels) is the lack of lubricity so that the fuel offers little or no damping which makes impacts within the injector problematic for wear. In addition, the valve needle in such injectors is often bigger than one in an injector for conventional liquid fuels and it is attached to a heavy magnetic armature, travelling over a great lift distance in order to inject the required amount of fuel. Impacts of the valve needle at the end of lift can therefore prevent problems for wear.

It is against this background that the invention has been devised.

### SUMMARY OF THE INVENTION

According to a first aspect, there is provided a fuel injector for delivering gaseous fuel to an internal combustion engine, the fuel injector comprising a valve needle which is engageable with a valve needle seat to control delivery of gaseous fuel in a combustion space; an actuator for causing the valve needle to move through a range of travel between a seated position in which it engages the valve needle seat and a fully open position; and a damping arrangement comprising a damping chamber filled with a damping fluid which serves to damp opening movement of the valve needle as it moves away from the valve needle seat and further comprising a damping valve which is cooperable with a damping valve seat to control the exit of damping fluid from the damping chamber to a low pressure drain, the damping valve being configured to disengage from the damping valve seat in response to movement of the valve needle.

The damping valve being configured to disengage from the damping valve seat in response to movement of the valve needle means that it is the movement of the valve needle that causes or brings about disengagement of the damping valve from the damping valve seat. In one embodiment, it is the actuation of the actuator that moves the valve needle e.g., upwardly, and it is in response to such movement of the valve needle that the damping valve disengages from the damping valve seat. By way of example, the damping valve may be configured to disengage from the damping valve seat part way through the travel of the valve needle between the seated position and the fully open position.

The damping valve seat may be defined by a drilling between the damping chamber and a low pressure drain, wherein the damping valve is operable to open and close the drilling to open and close the damping chamber to low pressure.

The valve needle may be engageable with the damping valve to effect opening of the damping valve by moving the damping valve away from the damping valve seating.

The damping valve controls the flow of damping fluid between the damping chamber and a second chamber. For example, the second chamber may be a chamber for housing a spring for the damping valve.

In another embodiment the second chamber may communicate with a restricted drilling to low pressure so as to control the rate of release of damping chamber fluid from the damping chamber.

By selecting the restriction size carefully the rate of decay of the damping fluid from the damping chamber can be controlled carefully beyond the point at which the damping valve is opened.

In one embodiment, the valve needle includes an opening member for the damping valve which may be a part carried by the valve needle or forming an integral part of the valve needle. For example, the opening member may be a pin at the end of the valve needle remote from the valve needle seating. The opening member is therefore operable to open the damping chamber part way through the range of travel to release the damping fluid from the damping chamber.

In order to open the damping chamber, the pin at the end of the valve needle is moved through the drilling to engage with the damping valve.

In this or any embodiment the damping valve may take the form of a ball valve, a plate valve or a piston valve.

In another embodiment the damping valve takes the form of a piston valve which may include a projection which extends through the drilling. Once the valve needle has moved part way through its range of travel, the end of the valve needle is brought into engagement with the projection to lift the damping valve away from the damping valve seat.

The damping valve may include a tubular section which receives an end of return spring for the piston valve which serves to urge the damping spring against the damping valve seat.

The damping arrangement may further comprise means for re-filling the damping chamber with damping fluid.

For example, the means for re-filling may be a means for continually re-filling the damping chamber after each injection event.

In one embodiment, the means for re-filling may take the form of a restricted drilling into the damping chamber (i.e. a re-filling restriction). The provision of the re-filling restriction into the damping chamber ensures that, even though the gaseous fuel is displaced from the damping chamber as the needle lifts and the ball valve is opened, fuel replenishes or refills the damping chamber during the closing phase of the valve needle, filling the chamber ready for the next injection event.

### BRIEF DESCRIPTION OF THE DRAWINGS

In order that the invention may be more readily understood, preferred non-limiting embodiments thereof will now be described, by way of example only, with reference to the accompanying drawings, in which:

FIG. 1 is a cross-sectional view of a fuel injector of a first embodiment of the invention;

FIG. 2 is an enlarged cross section of a region of the fuel injector of FIG. 1, including a damping arrangement for valve needle movement;

FIG. 3 is a graph to show the opening and closing movement of the valve needle of the injector in FIGS. 1 and 2 in (i) sealed mode and (ii) purged mode; and

FIG. 4 is an enlarged cross section of a region of the fuel injector, similar to FIG. 2, but with a modification to the damping arrangement in another embodiment of the invention.

In the drawings, as well as in the following description, like features are assigned like reference signs. Throughout this description, terms such as ‘upper’ and ‘lower’, and other directional references, are used with reference to the orientation of the fuel injector as shown in the accompanying drawings. However, it will be appreciated that such references are not limiting and that fuel injectors according to the invention can be used in any orientation.

### DETAILED DESCRIPTION OF THE INVENTION

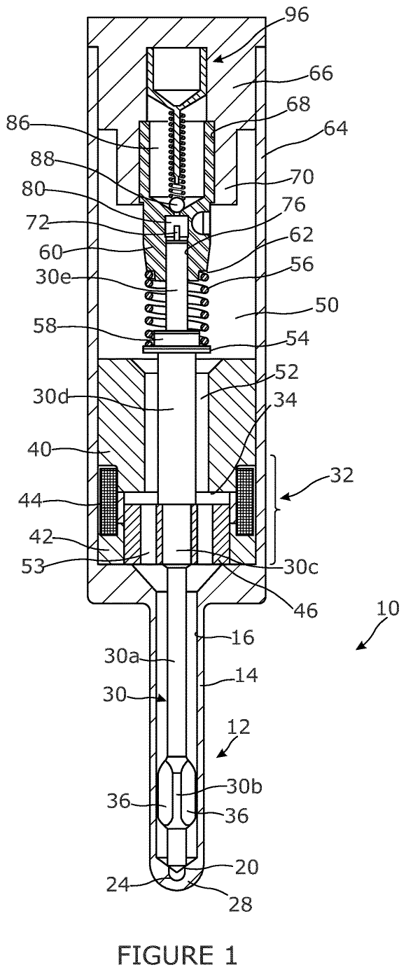

FIG. 1 shows a first embodiment of a fuel injector 10 or injector assembly for injecting gaseous fuel in an internal combustion engine. The fuel injector 10 is of the inwardly-opening type comprising an injection nozzle 12 having a substantially cylindrical nozzle body 14 that defines a nozzle bore 16. The nozzle bore 16 in turn defines a central bore axis which aligns with the longitudinal axis of the injector.

A valve seat 20 is disposed at a lower end (relative to the orientation of FIG. 1) of the nozzle bore 16, and comprises a generally annular contact area. The contact area of the valve seat 20 is a generally annular portion of a spherical surface. A sac volume 24 is defined within a nozzle tip 28 located at the lower end of the fuel injector 10, the sac volume 24 extending downwards from the opening defined by the valve seat 20. Several nozzle outlets (not visible in FIG. 1) extend through the nozzle tip 28. In practice the nozzle tip 28 may be provided with any number of outlets so as to ensure a high cross sectional flow area is available for gaseous fuel exiting the injector 10. This is especially important for a gaseous fuel injector where relatively high injection volumes are required for combustion. The nozzle body forms a lower extension of a main injector housing, the remaining parts of which will be described in further detail below.

The nozzle bore 16 receives a valve needle 30 which is operable by means of an actuator, referred to generally as 32, to control movement of the valve needle 30 through a range of travel. The full range of travel extends from a seated position of the valve needle 30, when the valve needle 30 is seated against the valve seat 20, and a full lift position when a part of the actuator engages a lift stop 34.

The valve needle 30 is made up of several different regions of varying diameter and form. A main valve needle stem 30a extends through the nozzle bore 16 and an enlarged diameter region (a guide region 30b) of the valve needle is located towards the lower end of the main valve needle stem 30a. The guide region 30b is cooperable with a portion of the nozzle bore 16 to guide movement of the valve needle through its range of travel. The guide region 30b is provided with axially formed grooves 36 to allow the passage of gaseous fuel through the nozzle bore 16 towards the sac volume 24.

The actuator 32 includes an actuator housing 40, an actuator core 42, a solenoid winding 44 and an armature 46. The armature 46 is connected with a further region of the valve needle (armature region 30c) which is of enlarged diameter compared to the main valve needle stem 30a. The armature region 30c of the valve needle therefore carries the armature 46. The actuator housing 40 has an internal profile which defines a step, the step defining the lift stop surface 34 for the upper face of the armature 46 as it is caused to move upwardly, upon actuation, carrying the valve needle 30 with it. The solenoid winding 44 is received within an outer recess in the actuator housing 40 and surrounds the armature 46. The solenoid winding 44 is supplied with an electrical current to generate an electromagnetic force through the core 42 to actuate the armature 46 to move upwardly (in the orientation shown). A third region 30d of the valve needle 30 extends upwardly beyond the armature 46 and is of enlarged diameter compared to the armature region 30c of the needle.

The flow of fuel through the injector originates at an injector inlet (not visible in the cross section) which introduces fuel into a spring chamber 50 defined above the actuator housing 40. From the spring chamber 50 the fuel flows onwards into a flow passage 52 which is defined in the actuator housing 40 and surrounds the third region 30d of the valve needle 30. The armature 46 is provided with axially-extending drillings 53 between its upper and lower surfaces which run parallel to the longitudinal axis of the injector to allow gaseous fuel which flows from the spring chamber 50 unto the fuel passage 52 to flow through the armature 46 towards the nozzle bore 16.

At the upper end of the third region 30d of the valve needle 30, a spring plate 54 is provided to define an abutment plate for a valve needle return spring 56 housed within the spring chamber 50. The return spring 56 acts on the valve needle 30 and serves to urge the valve needle 30 against the valve seat 20. An annular disc 58 is carried by the valve needle 30 immediately above the spring plate 54. The annular disc 58 and the spring plate 54 may be integrally formed. The annular disc provides a guidance feature for the spring 56 to keep the spring concentric in the arrangement. The spring 56 therefore has a lower end which abuts the spring plate 54 and an upper end which abuts a projection 60 into the spring chamber 50. The lower face of the projection 60 is provided with a step 62 to locate the upper end of the spring 56 which sits neatly into the step around the annular disc 58. The spring 56 is therefore compressed between the spring plate 54 and the lower face of the projection 60 and so applies a biasing force to the valve needle 30, serving to urge the valve needle 30 against the valve seat 20.

The main housing for the injector includes the nozzle body 16 and an elongate tubular housing part 64 which receives the actuator housing 40 and an insert 66 which closes the spring chamber 50. The actuator housing 40 and the insert 66 define the spring chamber 50 between them. The insert 66 is provided with a recess 68 within which the projection 60 is received in an interference fit. The insert 66 is itself of stepped diameter so that the portion of the insert 66 within which the recess 68 is defined is itself a projection 70 from the main body of the insert 66 into the spring chamber 50.

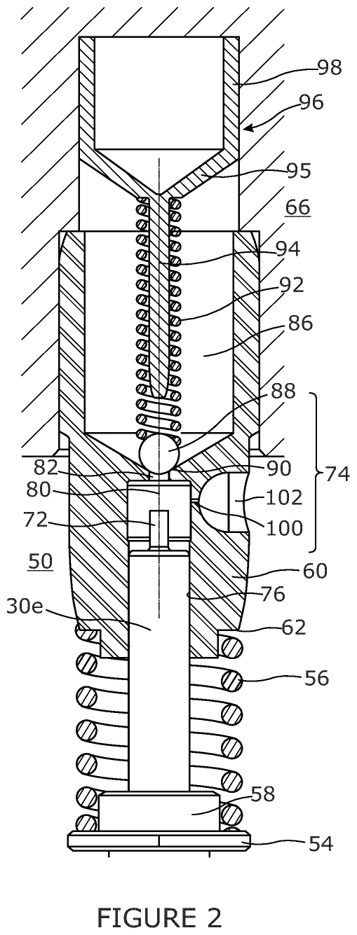

At its upper end and above the disc 58 the valve needle 30 includes an upper stem 30e which terminates in a projection or piston 72 of relatively small diameter. That part of the injector around the region of the projection 60 and the return spring 56 is shown in more detail in FIG. 2 where the piston 72 can be seen more clearly. The piston 72 forms a part of a damping arrangement of the injector, referred to generally as 74, which serves to damp movement of the valve needle 30 as it is lifted away from the valve seat 20, in use.

The upper valve needle stem 30e of the valve needle 30 is received within a bore 76 provided in the projection 60. The bore 76 and the upper face of the upper valve needle stem 30e together define a damping chamber 80 which receives gaseous fuel. The piston 72 at the end of the upper valve needle stem 30e extends into the damping chamber 80. The damping chamber 80 opens into a drilling 82 which communicates with a second spring chamber 86 defined within the projection 60. A damping valve in the form of a ball valve 88 is located within the second spring chamber 86 and seats against a ball valve seating 90 defined at the opening into the second spring chamber 86 at the end of the drilling 82. The damping valve 88 may also be referred to as a purge valve as it allows the damping chamber 80 to be purged, for reasons that will become apparent from the following description.

The ball valve 88 has a valve spring 92 which is received over and carried by a stem 94 projecting into the second spring chamber 86. The stem 94 forms an extension part of a Y-shaped housing part 96 which locates within the insert 66. One end of the valve spring 92 engages with the ball valve 88 and the other end of the valve spring 92 engages with the underside of the upper region of the Y-shaped housing part 96. The upper region of the Y-shaped housing part 96 includes a tubular section 98 which meets with the stem 94 via a frusto-conical region 95.

A further feature of the damping arrangement is a restriction 100 which is provided in the projection 60 so that it opens into a side wall within the damping chamber 80. The restriction 100 communicates with a supply passage 102 for gaseous fuel. The nozzle spring 56 is under compression in FIGS. 1 and 2, compressed between the projection 60 and the disc 58, holding the valve needle 30 in the closed position such that the valve needle 30 is engaged with the valve seat 20. The damping chamber 80 is filled with gaseous fuel due to the filling through the restriction 100 from the gaseous fuel supply passage 102. When the valve needle 30 is in this seated position, no gaseous fuel is able to escape from the sac volume 24 through the nozzle outlets and into the combustion chamber and so injection does not take place.

When fuel is to be injected by the fuel injector, the coil 44 of the actuator 32 is energised by application of an electrical current, thereby causing the armature 46 to move upwardly against the force of the spring 56. The valve needle 30 is therefore caused to move upwardly with the armature 46, lifting the valve needle 30 away from the valve seat 20 and initiating injection of gaseous fuel into the combustion chamber. Valve needle movement continues until the armature 46 has moved so far that its upper face engages with the lift stop 34, bringing the valve needle 30 to its full lift position.

The presence of the gaseous fuel in the damping chamber 80 applies a resistance force to lifting motion of the valve needle 30, which controls or damps lifting of the valve needle 30 as it moves through its range of travel. The gaseous fuel therefore acts as a damping fluid within the damping chamber 80. This ensures that at the end of its travel (i.e. when the valve needle 30 is fully lifted) there is no harsh impact between the armature 46 and the lift stop 34 to terminate valve needle movement, and the impact is cushioned.

The diameter of the axial length of the piston 72 is selected to be small enough so that, as the valve needle lifts, the piston 72 enters into the drilling 82 into the damping chamber 80, eventually making contact with the ball valve 88. Initially the piston 72 is distanced from the ball valve 88 (as shown in FIG. 2) and the damping chamber 80 is therefore sealed by the ball valve 88 which is biased against its seating 90 by the ball valve spring 92. This may be referred to as the ‘sealed mode’ of operation. The gaseous fuel within the damping chamber 80 is compressed during this movement of the valve needle (and the piston), causing the damping force which opposes needle lift to increase. Movement of the valve needle 30 continues to move the piston 72 towards the ball valve 88, into the drilling 82, and eventually bringing the piston 72 into direct contact with the ball valve 88. Continued movement of the valve needle 30 results in a lifting force being applied to the ball valve 88, by the piston 72, opposing the ball valve spring 92 and lifting the ball valve 88 away from the ball valve seating 90. As the ball valve 88 is lifted, gaseous fuel in the damping chamber 80 is able to escape into the second spring chamber 86, purging the damping chamber 80 of its damping fluid. Fuel does not accumulate within the second spring chamber 86 which is in communication with the fuel supply system. Hence, it is clear how the damping valve 88 is configured to disengage from the damping valve seat 90 in response to movement of the valve needle 30, meaning that it is the movement of the valve needle 30 that causes or brings about disengagement of the damping valve 88 from the damping valve seat 90. In particular, it is the actuation of the actuator 32 that moves the valve needle 30 upwardly, and it is in response to this upward movement of the valve needle 30, that the damping valve 88 disengages from the damping valve seat 90 to purge the damping chamber 80.

This phase of operation may therefore be referred to as the ‘purged’ mode of operation. Purging of the damping chamber has the effect of reducing the damping force acting against the valve needle 30 and tends to reduce the damping effect towards full lift. This is helpful as the damping force tends to oppose needle motion and it is not desirable for this to happen to such an extent that needle lift is adversely slowed.

When it is required to terminate injection the actuator 32 is de-energised by removing the current from the coil 44 and so the actuation force acting on the valve needle 30 is removed, thereby causing the valve needle 30 to be is urged once again to engage with the valve seat 20 under the force of the valve needle spring 56. As this happens the volume of the damping chamber 80 expands as the upper end of the valve needle 30 moves downwardly within the damping chamber 80, introducing a negative pressure within the damping chamber 80 and causing the ball valve 88 to return to the ball valve seating 90 under the force of the ball valve spring 92. At this point the valve needle 30 is ready again for the next injection.

The provision of the restriction 100 into the damping chamber 80 ensures that, even though the gaseous fuel is displaced from the damping chamber 80 as the needle lifts and the ball valve 88 is opened, fuel replenishes or refills the damping chamber 80 during the closing phase of the valve needle 30, filling the chamber 80 ready for the next injection event.

The purpose of the damping arrangement 74 is to avoid ‘needle bounce’ which can happen if the valve needle 30 is travelling relatively quickly in either an opening or closing direction. However, without the purging, the damping chamber 80 would act to slow the valve needle 30 opening, but would act as an accelerator for the valve needle 30 when closing. Purging therefore not only avoids the unwanted down force to seat the valve needle 30, but also generates a beneficial upwardly directed force during closing movement of the valve needle 30.

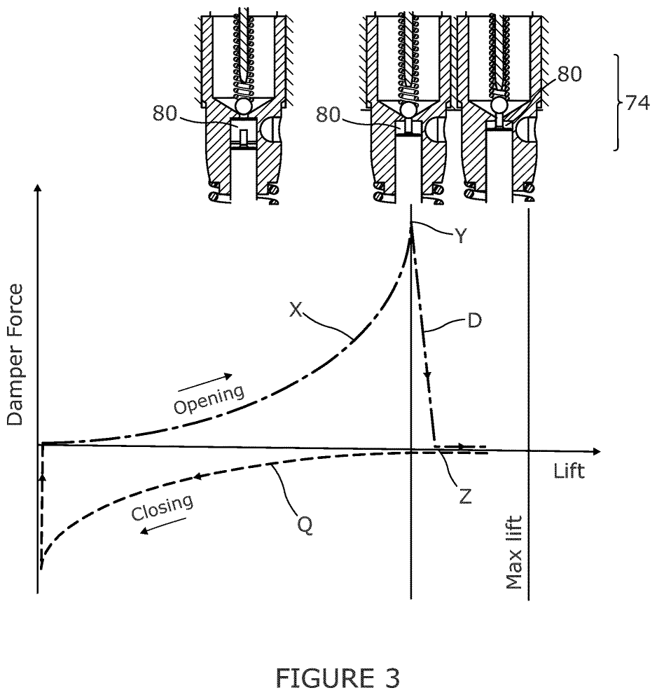

FIG. 3 shows the damping force profile for the injector in FIGS. 1 and 2 as a function of needle lift (i.e. distance the valve needle 30 has moved away from the valve seat 20) so that the effect of the damping arrangement 74 can be understood more clearly. It can be seen that for the opening lift (line X) the damping force increases, and continues to rise sharply, as gaseous fuel within the damping chamber 80 is compressed as the valve needle 30 moves to open the injector 10. In this damped phase of operation (sealed mode), the ball valve 88 is seated against the ball valve seating 90 and the damping chamber 80 is closed, applying the damping force to damp needle motion. The damping force is applied up until the point (point Y) at which the piston 72 hits the ball valve 88 to lift it from the ball valve seating 90. After this point continued movement of the valve needle 30 causes the gaseous fuel to be displaced from the damping chamber 80 so that there is a sharp decrease in the damping force (line D) until the damping chamber is fully empty at point Z. The damping force remains at zero until the valve needle 30 reaches maximum lift.

With the damping chamber 80 empty, the damping force remains zero as the valve needle 30 starts to move towards the valve seat 20. This is a purged mode of operation of the damping arrangement 74 where the ball valve 88 remains lifted from the ball valve seating 90 with the piston 72 withdrawing from the drilling 82 (i.e. the ball valve 88 is open). During this initial closing phase of movement of the valve needle 30 (until point Z), there is no damping force and valve needle movement is governed only by the return spring 56. However, after a short displacement of the valve needle 30 through the closing phase, the damping arrangement 74 switches to the sealed mode again with the piston 72 disengaged from the ball valve 88 and fully withdrawn from the drilling 82, with the ball valve 88 once again urged against the ball valve seating 90 under the valve spring 92 force. At or around this point continued movement of the valve needle 30 in the closing direction means that any trapped gas within the damping chamber 80 starts to expand creating a negative damping force which continues to increase (negative increase) as the valve needle 30 continues to its seated position. As the gaseous fuel within the damping chamber 80 expands the pressure becomes lower than that downstream of the damping arrangement 74 and the force opposing valve needle closure is increased. This can be seen in line Q in FIG. 3.

During the closing phase, the damping chamber 80 starts to refill through the restriction 100 so that there is damping fluid within the damping chamber 80 again once the valve needle 30 has seated, ready for the next injection event. The damping chamber 80 refills for as long as the pressure in the chamber 80 is lower than the supply pressure. Typically this refilling will start during the closing phase and will continue until the next injection. The diameter of the restriction 100 is small enough so that refilling during the closing phase is marginal compared to the refilling which occurs from the end of the closing to the next injection event. This is desirable so that during closing phase the pressure inside the damping chamber 80 is lower than the surrounding pressure and the upward force is generated.

It will be appreciated that with the damping arrangement 74 of the invention the damping force is dependent on the position of the piston 72, and not on the speed of movement the piston 72 (in other words the damping force is dependent on the position of the valve needle 30 and not the speed of movement of the valve needle 30). Another feature of the damping arrangement 74 is that the damping force is very low or zero when the valve needle 30 initially lifts, which is beneficial because the high lifting force is required to unseat the valve needle 30. The damping force remains relatively low for the earlier part of needle lift and increases more significantly towards the end of travel of the valve needle 30, precisely when a higher damping force is required to prevent impact at the end of valve needle lift. It will be appreciated that although the dimensions are such that the distances between (i) the piston 72 and the ball valve 88 and (ii) between the armature 46 and the stop surface 34 are very similar, the distance between the piston 72 and the ball valve 88 is slightly less.

In other embodiments the damping ball valve may be replaced with another type of valve, for example a plate or poppet valve.

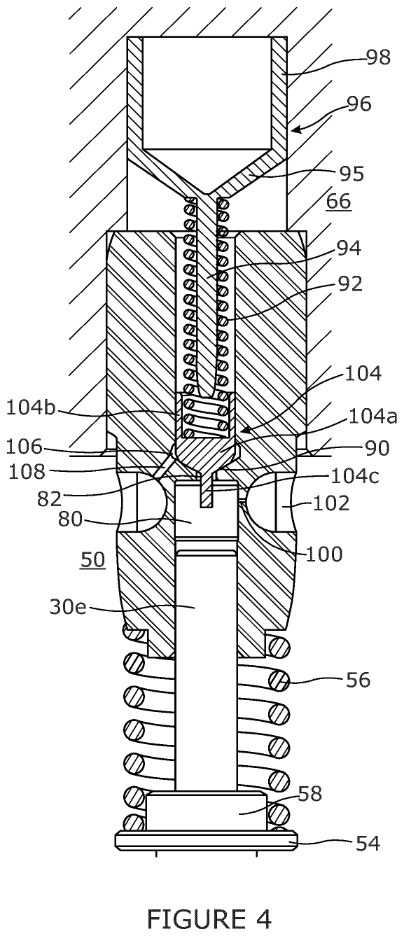

One example of an alternative embodiment is shown in FIG. 4. In this case the ball valve is replaced with a piston valve 104 and the valve needle itself has a flat end surface which faces the piston valve 104. The piston valve 104 includes a main body in the form of a piston head 104a and a tubular end portion 104b. The head 104a of the piston valve includes a projecting pin 104c which extends through the drilling 82 into the damping chamber 80. The head 104a of the piston valve 104 is engageable with a valve seating 90 defined within a piston valve chamber 106 formed in the projection 60. The piston valve chamber 106 has a different form to that shown in FIGS. 1 and 2 and does not house the spring 92, and so is of relatively low volume. Instead, the lower end of the spring 92 is housed within the tubular section 104b of the piston valve 104. As before the upper end of the spring 92 engages with the underside of the frusto-conical region 95 of the Y-shaped housing part 96, as in FIGS. 1 and 2.

A further modification in FIG. 4 is the provision of a restricted drilling 108 which communicates with a low pressure drain (not shown). The restricted drilling 108 is provided in the projection 60 and communicates with the piston valve chamber 106. This restricted drilling 108 provides a means of varying the inclination of the decaying damping force versus needle lift profile, as shown in FIG. 3, in the region (line D) between points X and Y of needle lift. In other words, the restricted drilling 108 provides a means of controlling the pressure drop in the damping chamber 80 when the damping arrangement 74 is in the purged mode and the piston valve 104 is lifted from the valve seating 90 as it restricts the rate at which gaseous fuel within the damping chamber 80 can escape to low pressure. This may be beneficial, for example, as it may be helpful to for an injection event to follow in close succession after a previous injection event, so that a more rapid decay of the damping force is beneficial (line D in FIG. 3) to return the valve needle 30 to the valve seat 20 more quickly. The ability to be able to tune the damping characteristic by selecting an appropriate size for the restricted drilling 108 provides an advantage.

Operation of the injector in FIG. 4 is similar to that in FIG. 3, with the damping arrangement 74 having a purged mode and a sealed mode depending on the extent of lift of the valve needle 30 away from the valve seat 20. Initially, when the valve needle 30 is seated, the end of the upper stem 30e is displaced from the pin 104c on the piston valve 104. In this sealed mode the damping chamber 80 is closed to the low pressure drain so that as the valve needle 30 starts to lift away from the valve seat 20, gaseous fuel within the damping chamber 80 is compressed and a damping force is applied to the needle 30 as it lifts. Also as the valve needle 30 starts to lift, the end of the upper stem 30e moves towards and eventually engages with the end of the pin 104c, pushing the piston valve 104 upwards, against the force of the piston valve spring 92, and lifting the piston valve 104 from the piston valve seating 90. At the point at which the piston valve 104 lifts away from the piston valve seating 90, the damping chamber 80 is opened to low pressure via the restricted drilling 108, and gaseous fuel can escape the damping chamber 80 at a restricted rate. This is the purged mode of operation of the damping arrangement 74. The rate of restricted flow out of the damping chamber 74 influences the decay in damping force, between points Y and Z as illustrated in line D of FIG. 3.

Once the actuator is de-energised and the valve needle 30 is returned to the valve seat 20 once again under the force of the valve needle spring 56, and the gaseous fuel in the damping chamber 80 expands, pressure in the damping chamber 80 reduces allowing the piston valve 104 to close again under the force of the piston valve spring 92. The damping arrangement 74 is therefore returned to the sealed mode. As illustrated in FIG. 3, the damping force is negative in this phase and the closing force is resisted (damped) to a greater extent as the valve needle approaches the valve seat 20.

In other embodiments of the invention the damping chamber 80 need not be filled with gaseous fuel (i.e. the fuel for injection) and may be filled with another fluid, such as an oil or another lubricant.

In any of the embodiments of the invention it is an advantage that the damping characteristic matches the actuation force profile for the solenoid actuator 32. During valve needle opening the actuator 32 delivers a non-linear force, so that at the early opening of the valve needle 30 the actuation force is very weak, but then towards and at the end of opening the actuation force is very strong. The damping arrangement 74 compliments this actuation force profile: at the early opening of the valve needle 30 the damping is very low (when the actuation force is weak) but then towards the end of the opening movement the damping profile is very high (when the actuation force is very high). The effect of the heavy damping towards and at the end of valve needle opening is to avoid high impacts between the valve needle and its lift stop 34, benefitting control of injection and service life of the parts.

It will be appreciated that other embodiments of the invention are envisaged without departing from the scope of the appended claims and the function of the injector claimed therein.

For example, in one embodiment, there isn't any need for any direct engagement between the upper valve needle 30e and the damping valve 88, 104 to disengage the damping valve 88, 104 from the damping valve seating 90 (i.e., there isn't any need for the piston 72 or pin 104c mentioned above, which ensure direct engagement between the upper valve needle 30e and the damping valve 88, 104 to bring about said disengagement). Instead, the damping valve 88, 104 may be configured to disengage from the damping valve seating 90 when the pressure within the damping chamber 80 exceeds a threshold value, i.e. due to compression of the fuel in the damping chamber 80 under the activation of the valve needle 30 during opening of the injector 10. Such a damping arrangement 74 is suitable for both gaseous and liquid fuel injectors 10, and is particularly advantageous for fuel injectors 10 configured to inject incompressible liquid fuels.

### LIST OF PARTS

10—fuel injector
12—injection nozzle
14—nozzle body
16—nozzle bore
20—valve seat
24—sac volume
28—nozzle tip
30—valve needle
30a—valve needle stem
30b—guide region
30c—armature region
30d—third region of the valve needle
30e—upper stem of the valve needle
32—actuator
34—lift stop
36—grooves
40—actuator housing
42—actuator core
44—solenoid winding
46—armature
50—spring chamber
52—fuel passage
53—axially extending drillings
54—spring plate
56—return spring
58—annular disc
60—projection
62—step of projection
64—tubular housing part
66—insert
68—recess
70—projection from insert
72—piston
74—damping arrangement
76—bore
80—damping chamber
82—drilling
86—second spring chamber
88—ball valve
90—valve seating
92—valve spring
94—stem
95—frusto-conical section of Y-shaped housing part
96—Y-shaped housing part
98—tubular section of Y-shaped housing part
100—restriction
102—supply passage
104—piston valve
104a—piston head
104b—tubular end portion
104c—projecting pin
106—valve chamber
108—restricted drilling

1. A fuel injector for delivering gaseous fuel to an internal combustion engine, the fuel injector comprising:
a valve needle which is engageable with a valve needle seat to control delivery of gaseous fuel in a combustion space;
an actuator for causing the valve needle to move through a range of travel between a seated position in which it engages the valve needle seat and a fully open position; and
a damping arrangement comprising a damping chamber filled with a damping fluid which serves to damp opening movement of the valve needle as it moves away from the valve needle seat and further comprising a damping valve which is cooperable with a damping valve seat to control the exit of damping fluid from the damping chamber to a low pressure drain, the damping valve being configured to disengage from the damping valve seat in response to movement of the valve needle.

2. The fuel injector as claimed in claim 1, wherein the damping valve is operable to open and close a drilling which communicates with the damping chamber to open and close the damping chamber to low pressure.

3. The fuel injector as claimed in claim 1, wherein the valve needle is engageable with the damping valve to move the damping valve away from the damping valve seat.

4. The fuel injector as claimed in claim 1, wherein the valve needle includes an opening member for the damping valve which is a part carried by the valve needle or forming an integral part of the valve needle.

5. The fuel injector as claimed in claim 4, wherein the opening member is a pin at the end of the valve needle remote from the valve needle seat which is engageable with the damping valve.

6. The fuel injector as claimed in claim 5, wherein the damping valve is operable to open and close a drilling which communicates with the damping chamber to open and close the damping chamber to low pressure,
wherein the pin at the end of the valve needle is moved through the drilling to engage with the damping valve.

7. The fuel injector as claimed in claim 2, wherein the damping valve is a piston valve including a projection which is received into the drilling.

8. The fuel injector as claimed in claim 7, wherein the piston valve includes a tubular section which receives an end of a return spring for the piston valve which serves to urge the piston valve against the damping valve seat.

9. The fuel injector as claimed in claim 1, wherein the damping valve is configured to disengage from the damping valve seat in response to the pressure within the damping chamber exceeding a threshold value.

10. The fuel injector as claimed in claim 1, wherein the damping arrangement further comprises a second chamber, and wherein the damping valve controls the flow of damping fluid between the damping chamber and the second chamber.

11. The fuel injector as claimed in claim 10, wherein the valve needle includes an opening member for the damping valve which is a part carried by the valve needle or forming an integral part of the valve needle,
wherein the second chamber is a spring chamber for housing a spring for the damping valve.

12. The fuel injector as claimed in claim 10, wherein the damping valve is operable to open and close a drilling which communicates with the damping chamber to open and close the damping chamber to low pressure, and the damping valve is a piston valve including a projection which is received into the drilling,
wherein the second chamber communicates with a restricted drilling to low pressure so as to control the rate of exit of damping chamber fluid from the damping chamber via the second chamber.

13. The fuel injector as claimed in claim 1, further comprising means for re-filling the damping chamber with damping fluid.

14. The fuel injector as claimed in claim 13, wherein the means for re-filling is a means for continually re-filling the damping chamber.

15. The fuel injector as claimed in claim 14, wherein the means for re-filling takes the form of a restricted drilling into the damping chamber.
